(19) United States
(12) Patent Application Publication
(10) Pub. No.: US 2012/0163742 A1
(43) Pub. Date: Jun. 28, 2012

(54) AXIAL GAS THRUST BEARING FOR ROTORS IN ROTATING MACHINERY

(75) Inventors: Harald Underbakke, Sandnes (NO); Svend Tarald Kibsgaard, Porsgrunn (NO); Lars Brenne, Sandnes (NO)

(73) Assignee: Statoil ASA, Stavanger (NO)

(21) Appl. No.: 13/379,958

(22) PCT Filed: Jun. 22, 2010
(86) PCT No.: PCT/NO2010/000237

§ 371 Date: Mar. 9, 2012

(30) Foreign Application Priority Data
Jun. 22, 2009 (NO) 20092379

(51) Int. Cl. F04D 29/051; F16C 32/06

(52) U.S. Cl. 384/123; 384/124

(57) ABSTRACT

An axial gas thrust bearing for rotors in rotating machinery includes at least one radial disk, integral with or fastened to the rotor and one fixed seal facing each disk or two fixed seals positioned to surround each disk, lower portions of the seals being situated at a distance from the rotor to allow the inflow of compressed fluid passing in the gap between the respective disk and seals, thereby combining the properties of a balance piston and thrust bearing disk.

The present invention relates to a gas bearing for rotors in rotating machinery combining the properties of a balance piston and thrust bearing disk.

A conventional rotor for rotating machinery such as a compressor, for instance, is supported by oil lubricated bearings. The bearings are located in atmospheric bearing housings. Therefore the bearings must be separated from the compressor impellers exposed to gas at high pressure by dry gas seals.

Turbo machinery with dedicated bearing, balance piston and seals has existed more than 100 years. Common to all are the requirement for complex and vulnerable support systems.

Radial and thrust bearings used in turbo machinery are bearings typically having shoes or pads on pivots. When the bearing is in operation, the rotating part of the bearing carries fresh oil in to the pad area. Fluid pressure causes the pad to tilt slightly, thereby building a wedge of pressurized fluid between the shoe and the other bearing surface. The pad tilt adaptively changes with bearing load and speed. Various design details ensure continued replenishment of the oil to avoid overheating and pad damage.

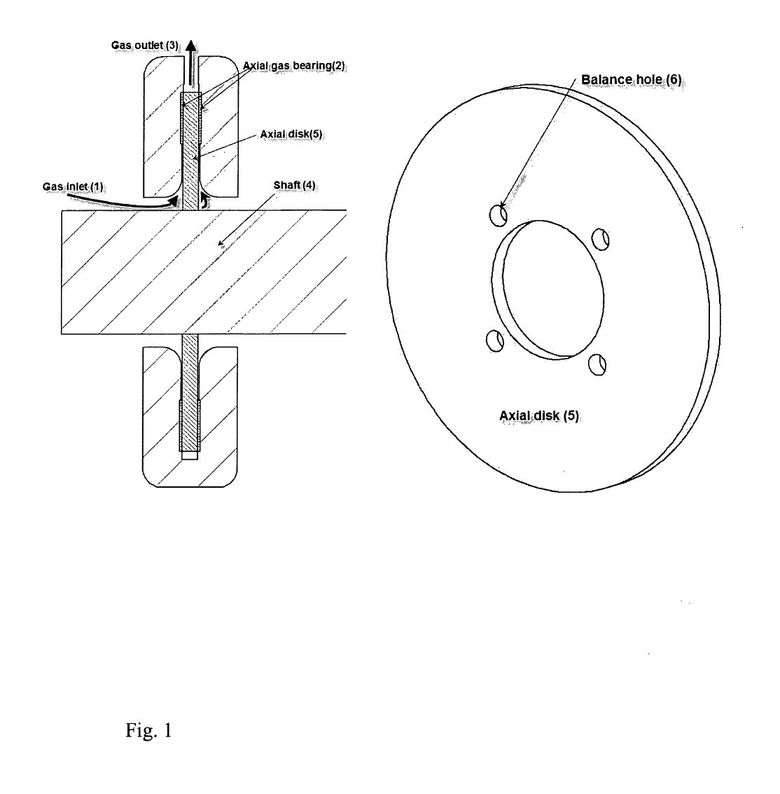

Due to the pressure rise developed through the impeller, a pressure difference exists across the hubs and covers involving the impellers have a net thrust in the direction of the compressor inlet. This effect is counteracted by means of a balance piston, see FIG. 1, being located behind the last impeller as to be accomplished by subjecting the outboard side of the balance piston to a low pressure from the inlet side of the compressor. Thus, a pressure differential is created opposite to the direction of the impellers. This pressure is achieved by connecting the area behind the piston to the inlet using a line.

An important step in the direction against an improved solution is shown by WO-A₁ 2008/018800 disclosing a combined bearing system wherein the rotor is provided with radial bearings and associated seals. Each radial bearing and sealing point for the rotor is in the form of a bearing and seal combination being formed of a stator located within the machinery housing, and the stator is formed with a bore.

By providing an axial bearing in the form of a cylindrical disk/impeller on the rotor resting against an associated portion of the stator, a gas film can be formed with rigidity and damping according to the same principle as in a radial gas bearing with desired dynamic rigidity and damping. Alternatively, the axial bearing can be formed according to the hydrostatic principle, which involves a flow restriction before and after the bearing surface, so as to obtain rigidity with accompanying damping. The axial bearing can also be formed using a combination of the two principles.

The main objective of the present invention is to replace conventional balance piston and thrust bearings with a simplified axial gas thrust bearing wherein the axial movement in the shaft reduces the distance between the rotating disk/impeller and the stationary radial wall, i.e. fluid forces increases that stops further shaft movement in the axial direction. The radial length of the axial thrust bearing and, thus, the gap between stator and disk, is depending on the pressure ratio against the machine, and the radial location of the gas bearing area, creating fluid forces, should be optimised further with respect to frictional losses and load capability.

This objective is achieved by an axial bearing for rotors in rotating machinery, wherein the bearing is comprising a at least one radial disk, integral with or fastened to the rotor and one fixed seal facing each disk or two fixed seals positioned to surround each disk, lower portions of the seals being situated in distance from the rotor to allow the inflow of compressed fluid passing in the gap between the respective disk and seals, thereby combining the properties of a balance piston and thrust bearing disk.

The air gap geometry formed inside the axial gas bearing include but not limited to, a) converging, b) diverging, and c) parallel. Further, the gas supplied to the air gap in the axial gas bearing may come from the radial inner or outer side of the bearing. It is also to be understood that the term “disk” shall include an impeller and the like.

The rotating disk or stator roughness can be in the form of different special defined geometries, such as but not limited to pockets, honeycomb (HC) or hole pattern (HP), not illustrated.

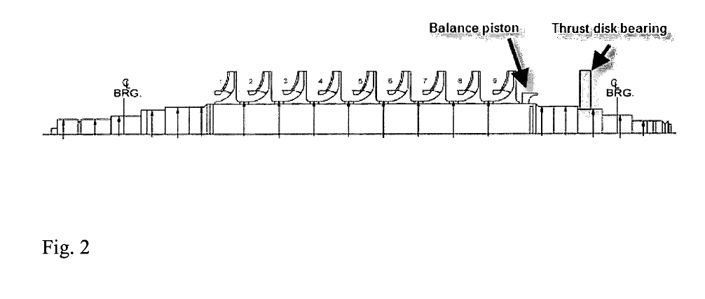

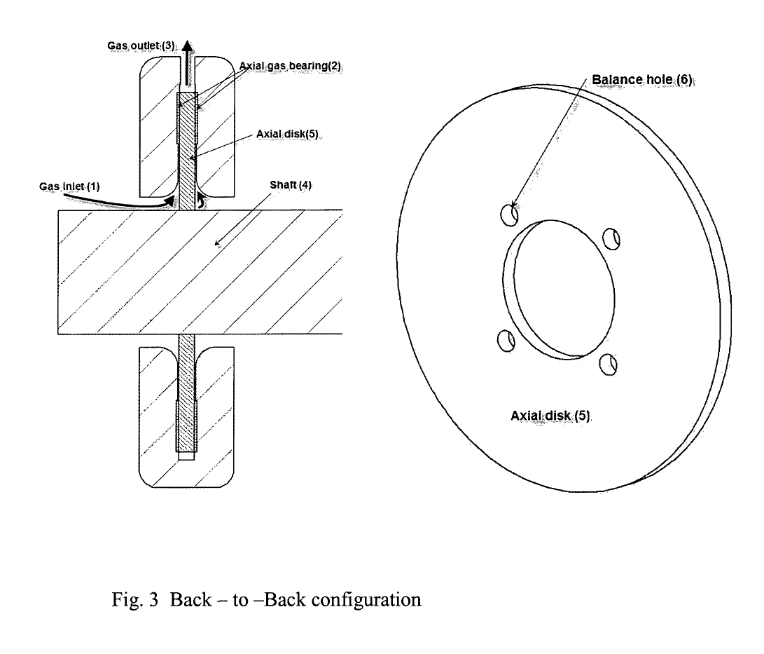

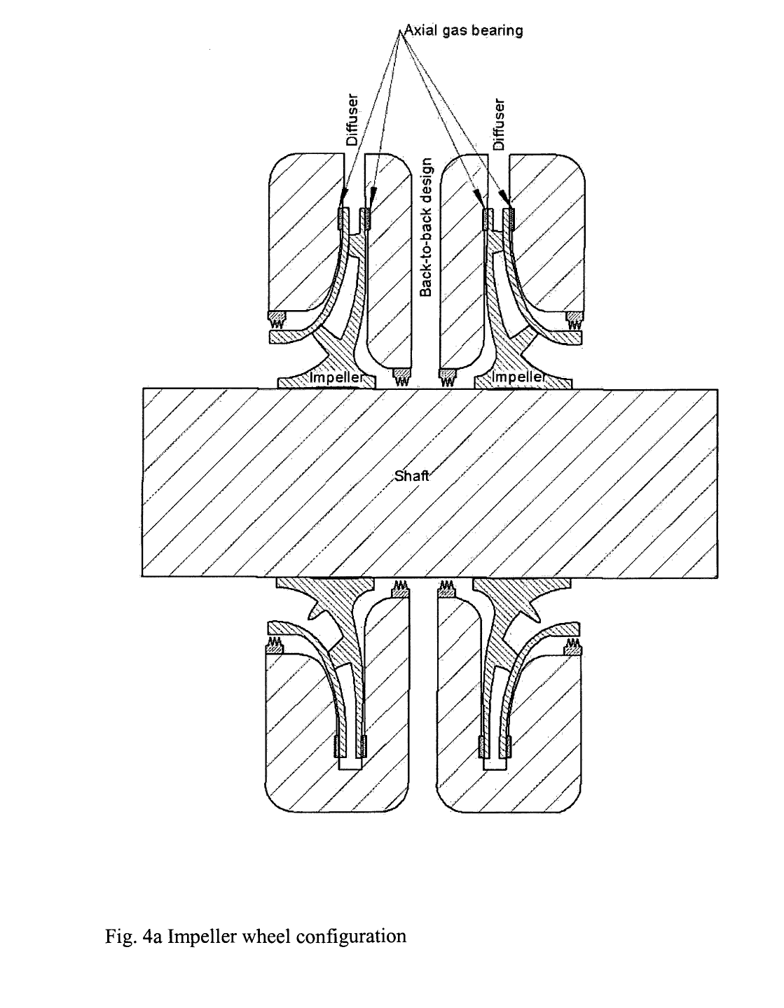

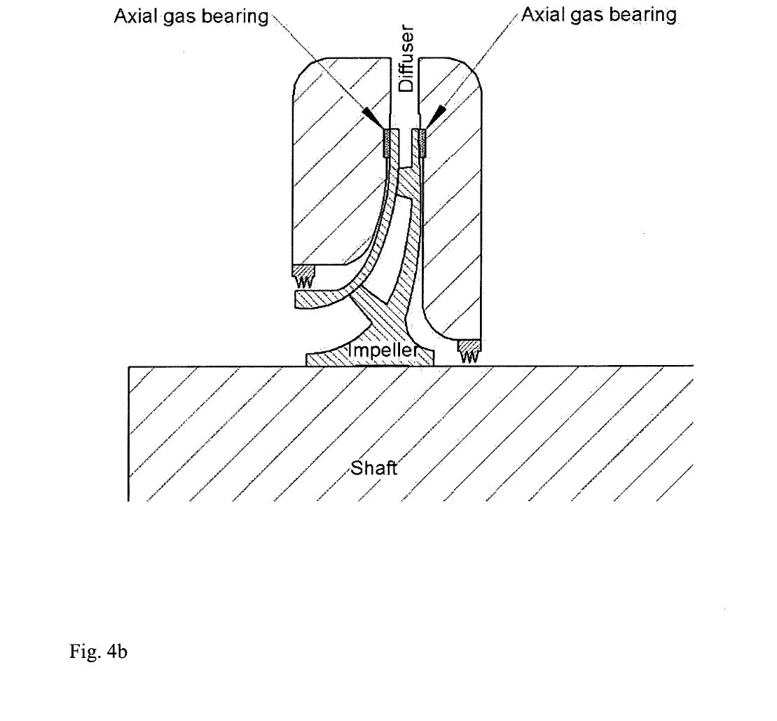

There are multiple configurations possible:
1. Axial disk configuration, see FIG. 2. Use a typical axial disk where the axial gas bearing is located on each side of the disk radial surfaces. Process gas is supplied to both sides of this disk, either from outer or inner side, from but not limited to the compressor last stage impeller, i.e. such a gas axial bearing will be double acting and be able to stabilise axial shaft movement in both directions. Further, the used gas from this axial gas thrust bearing is returned back to the compressor suction side.
2. Back-to-back compressor configuration, see FIG. 3. Utilise the same axial gas bearing principle as for axial disk configuration, however the impeller hub is utilised as the rotating part while the axial gas bearing stator is located between the 2 compressor sections. Process gas is supplied from the last impeller in each compressor section, and the fluid passing in the air gap between the impeller and the stator will create the gas bearing load capacity, thereby combining the function of a balance piston and thrust bearing.
   The leakage rate and gas bearing pressure can be controlled by installing a valve down stream of the thrust bearing, obtaining a controllable leakage rate and force/damping coefficients. Such a valve could also be adjustable in the operating speed range in order to optimise both rotordynamics and compressor efficiency.
3. Impeller wheel configuration, see FIG. 4. Utilise the same axial gas bearing principle as for axial disk configuration, however utilise all impeller wheels with surrounding stator walls through the compressor as a thrust bearing on one or both sides of the impeller radial surface to equalise the net axial force from the impeller. Such axial gas bearing solution would possible reduce the stage leakage and might eliminate or reduce the need for inter stage seals (labyrinths) throughout the compressor.

Other favourable aspects of the present invention are to be understood from the dependent claims and the discussion below.

The rotor can be shorter and stiffer giving rise to better rotor-dynamic performance and/or shorter and thinner involving weight savings. Conventional centrifugal gas compressors or compact hermetically sealed motor driven compressors are two useful but not the only application wherein the invention is expected to have advantages.

The present invention will now be discussed in more detail with the aid of preferred illustrative embodiments shown in the drawings, in which:

FIG. 1 shows a schematic sectional view of the traditional design for a rotor in a compressor having a balance piston and thrust disk bearing; and

FIG. 2 shows a schematic sectional view of a preferred embodiment according to the present invention having a radial disk and a gas bearing stator surrounding the disk, thereby combining the function of such prior art balance piston and thrust bearing;

FIG. 3 shows a schematic sectional view of a preferred embodiment according to the present invention using the impeller hub as disk and the surrounding wall as the gas bearing stator. This applies to both sections in the back to back compressor, thereby combining the function of such prior art balance piston and thrust bearing; and

FIG. 4 and b shows a schematic sectional view of a preferred embodiment according to the present invention using one or several impellers as rotating disk(s) and the surrounding surfaces as the gas bearing stator, thereby combining the function of such prior art balance pistons and thrust bearing.

Although a compressor is mentioned in the discussions here, all other forms of rotating machinery are applicable such as pumps, turbines and expanders wherein a fluid, for instance gas, is to be given an increased or reduced pressure.

The axial bearing requires pressure differential to function. An arrangement for start/stop may therefore be required. This could be achieved by aerostatic action pulling gas from an accumulator or by use of a reduced capacity back-up bearing of suitable type, not illustrated.

The present invention is disclosing a axial gas thrust bearing for rotors 4 in rotating machinery, wherein the bearing comprises at least one radial disk 5, integral with or fastened to the rotor 4 and one fixed seal 2 facing each disk or two fixed seals 2 positioned to surround each disk. The lower portions of the seals are situated in distance from the rotor to allow the inflow of compressed fluid passing in the gap between the respective disk and seals. Thus, the inventive concept is combining the properties of a balance piston and thrust bearing disk into only one component. This new concept conduct the work required identical to the old solution but with less space and no support system.

Thus, it is presupposed use of a standard type of radial disk 5, or impeller wheel as mentioned above, with a plane surface face to face with the respective seal, or the disk can alternatively be enhanced with a groove type of disk to obtain a higher load capacity in axial direction, not illustrated. To ensure the gas high pressure being divided equally to both sides, the radial disk itself can contain at least one balanced hole 6, thereby allowing for equal pressure between the two sides of the disk. As shown in FIG. 2, there are four such holes but it is understood that another number is equally applicable.

FIG. 3 provides a solution for a compressor type called back-to-back wherein two sections internally in one compressor are compressing the gas. The highest outlet pressure from each section meets in the center of the machine. For this configuration the gas leaks from high pressure in each section are leaking across the impeller axial balance seal back to suction or used as a cooling gas for integrated motor-compressor macines.

In FIG. 4 the gas pressure leaks from the high pressure to the low pressure side. The net axial force is generated by the pressure and surface of the impeller. Due to the reduced area on one side of the impeller, the axial force is not balanced but combining this axial seal on side is equalizing the axial force from the pressure. This can be utilized for one or more impellers in a favourable configuration configuration, thereby obtaining a limited amount of axial force.

The gas with increased pressure from the compressor is entering a radial seal 2. In a favourable configuration of such seals, the rotating disk 5 should be smooth whereas the stator surface should be rough to reduce leakage and enhance dynamic coefficients of stiffness and damping. The stator roughness can be in the form of honeycomb (HC) or hole pattern (HP) tapered seal, not illustrated. As depicted in FIG. 2, the seals can be convergent in the radial direction, or alternatively in parallel or divergent with the disk, or even any combination thereof. Thus, the seal design and bearing properties is able to define the ultimate system.

When the gas flows across the seal surface a pressure force is generated in the axial direction producing stiffness and damping. This stiffness and damping is trying to maintain a centre shaft position between the two seals. When the gas has left the exit of the two radial 2 seals it return backs to suction 3 of the compressor as a normal compressor balance piston system.

If extreme thrust forces are ongoing it is possible to balance the bearing by applying a longer radial length for the radial HP or HC seals 2 in the direction requiring additional force, i.s active or passive thrust. The distance between the rotor 4 and the lower end of at least the seal facing the impellers can also be varied to adjust the inflow of gas along the sides of the disk 5.

Thus, the present invention uses gas forces generated between a rotating disk and two radial seals to balance a turbo compressor in axial direction. The integrated solution provides thrust bearing properties, i.e. stiffness, damping and load capacity, between the disk and seals. The balance in axial direction can be achieved by adjusting one of the radial seals to provide more or less bearing properties.

By moving the balance piston from leaking in axial direction to radial a significant positive effect is expected in term of stability of the rotor i.e. rotor dynamics effect. The shaft length is reduced drastically which is favouring for critical speed and compact machines. The machinery is not sensitive to radial vibration because the seal is located in axial direction, normally radial seals get damage over time. Due to the disk length it is expected a considerable amount of load capacity in this specific design.

1. An axial gas thrust bearing for rotors in rotating machinery, comprising:
at least one radial disk, integral with or fastened to the rotor; and
one fixed seal facing each disk or two fixed seals positioned to surround each disk, lower portions of the seals being situated at a distance from the rotor to allow the inflow of compressed fluid passing in a gap between the respective disk and seals, thereby combining the properties of a balance piston and thrust bearing disk.

2. The axial gas thrust bearing according to claim 1, wherein the seal is radial convergent, divergent or in parallel with the radial disk or combinations thereof.

3. The axial gas thrust bearing according to claim 1, wherein the seal is variable in their radial extension as to balance the bearing for extreme thrust forces.

4. The axial gas thrust bearing according to claim 1, wherein the seal is provided with a honeycomb or hole pattern in the surfaces facing the disk.

5. The axial gas thrust bearing according to claim 1, wherein the distance between the rotor and at least the seal facing the inflowing fluid is variable as to alter the damping and stiffening properties of the bearing.

6. The axial gas thrust bearing according to claim 1, wherein the radial disk is formed with plane or grooved surfaces facing the seal.

7. The axial gas thrust bearing according to claim 1, wherein the radial disk is provided with at least one balance hole.

8. The axial gas thrust bearing according to claim 2, wherein the seal is variable in their radial extension as to balance the bearing for extreme thrust forces.

9. The axial gas thrust bearing according to claim 2, wherein the seal is provided with a honeycomb or hole pattern in the surfaces facing the disk.

10. The axial gas thrust bearing according to claim 3, wherein the seal is provided with a honeycomb or hole pattern in the surfaces facing the disk.

11. The axial gas thrust bearing according to claim 2, wherein the distance between the rotor and at least the seal facing the inflowing fluid is variable as to alter the damping and stiffening properties of the bearing.

12. The axial gas thrust bearing according to claim 3, wherein the distance between the rotor and at least the seal facing the inflowing fluid is variable as to alter the damping and stiffening properties of the bearing.

13. The axial gas thrust bearing according to claim 4, wherein the distance between the rotor and at least the seal facing the inflowing fluid is variable as to alter the damping and stiffening properties of the bearing.

14. The axial gas thrust bearing according to claim 2, wherein the radial disk is formed with plane or grooved surfaces facing the seal.

15. The axial gas thrust bearing according to claim 3, wherein the radial disk is formed with plane or grooved surfaces facing the seal.

16. The axial gas thrust bearing according to claim 4, wherein the radial disk is formed with plane or grooved surfaces facing the seal.

17. The axial gas thrust bearing according to claim 5, wherein the radial disk is formed with plane or grooved surfaces facing the seal.

18. The axial gas thrust bearing according to claim 2, wherein the radial disk is provided with at least one balance hole.

19. The axial gas thrust bearing according to claim 3, wherein the radial disk is provided with at least one balance hole.

20. The axial gas thrust bearing according to claim 4, wherein the radial disk is provided with at least one balance hole.
